(19) United States
(12) Patent Application Publication
(10) Pub. No.: US 2022/0006221 A1
(43) Pub. Date: Jan. 6, 2022

(54) Apparatus, System and Method for a Press Connection of Flex Cables

(71) Applicants: Ingrid van Welie, Newton, MA (US); Leonard Kogos, Salem, MA (US)

(72) Inventors: Ingrid van Welie, Newton, MA (US); Leonard Kogos, Salem, MA (US)

(21) Appl. No.: 16/920,503

(22) Filed: Jul. 3, 2020

(51) Int. Cl. H01R 12/79; H01R 12/77; H01R 12/91

(52) U.S. Cl. CPC H01R 12/79; H01R 12/91; H01R 12/774

(57) ABSTRACT

The invention relates to an apparatus, system and method for a direct flex cable to flex cable connection, with guides through which the said flex cables are aligned upon insertion and a pressing mechanism which in its latched state perfectly aligns corresponding guides to each other and by extension also aligns corresponding contact pads on the flex cables, and brings them into firm electrical contact.

### CROSS-REFERENCE TO RELATED APPLICATIONS

I hereby claim benefit under Title 35, United States Code, Section 119(e) of U.S. provisional patent application No. 62/895,640 filed Sep. 4, 2019. The 62/895,640 application is hereby incorporated by reference into this application.

### STATEMENT REGARDING FEDERALLY SPONSORED RESEARCH OR DEVELOPMENT

This invention was made with government support under SBIR Grant No. R43MH118155 awarded by the Department of Health and Human Services, National Institutes of Health. The U.S. government has certain rights in the invention.

### BACKGROUND OF INVENTION

### Field of the Invention

This invention relates generally to apparatus, systems and methods for connecting flex cables to one another. More specifically, at least one embodiment relates to a flex cable-to-flex cable press connector.

### Description of the Related Art

Today's neuroscience research holds great promise in improving human wellbeing by increasing the understanding of disorders that affect the brain, spinal cord, and nerves. Research in this area often relies on neuronal signal recording performed on laboratory animals, for example, small rodents. Electrical recordings are frequently made from a study-animal's target neurological system including the brain with the aid of small electrical probes containing electrode interfaces that are positioned close enough to the target cells to pick up the neural signals. The output of such probes is connected to neural amplifiers that acquire and amplify the relatively small neural signals before they are transmitted to other electrical circuitry for further processing. Generally, large numbers of small recording sites are employed, each requiring a wire to connect individual electrode interface to the neural amplifiers. The high density of these small recording sites (for example, conductors on the order of 20 microns in width and 15-50 microns in thickness) increases the difficulty in completing all the necessary electrical connections.

Typically, neural activity is monitored over a period that is determined to be sufficient to monitor desired neuronal dynamics. In this sense, the research is often performed on an on-going, chronic, basis on study-animals that are repeatedly connected to the neural amplifiers on a temporary basis to collect data. The probe remains installed in the animal between each period of data-collection while the external electrical circuitry is otherwise disconnected. The external electrical connections and electronic circuitry can be relatively bulky and heavy relative to the size of the study animals. For example, a mouse can only carry a load of approximately 10 grams without being functionally impaired. Thus, there is a need to provide a lightweight, temporary means of completing the electrical connections between the probe and the external circuitry including the amplifiers.

An additional challenge is created due to the necessity to locate the neural amplifiers along the signal path as close as possible to the probes themselves to obtain the desired signal quality. For example, noise levels should be <5 μvolts in saline, with neural signals in the range of 50-200 μvolts.

Probes with low channel counts (e.g. up to 64 channels) can have neural amplifiers small enough to integrate directly on the probe body. However, the current smallest commercial amplifier chip can only handle 64 channels and this chip measures 9 by 7 mm, which is large relative to the high-density probe body which can be a couple of mm. Attaching these amplifiers directly to the probes makes fabrication overly complicated, and is furthermore impractical for higher channel counts because of the need to integrate multiples of 64 channel amplifier chips on a single probe. Alternatively, custom chips can be designed for high-density applications, but this is an extremely costly approach. Another approach is to attach probes directly onto printed circuit boards (PCBs) with neural amplifiers soldered onto the PCBs. However, PCBs are bulky and heavy, severely limiting possible experiments to head-fixed configurations where the combined probe & PCB assembly is supported and maneuvered by a micro-manipulator.

To overcome the immediately preceding limitation, the probes can be soldered onto a flex cable that detaches them from the PCB or other external electronics while still ensuring electrical connection. However, the size and bulk of conventional electrical connectors, even those designed for small conductors, presents yet another challenge to applications that require small lightweight but high-density connectivity. Flex cable-to-board connectors with up to hundreds of connections that are still small and lightweight enough to put on a mouse's head for example, do not exist. The preceding shortcoming is especially problematic where the connection is employed to complete all the electrical connections, which can be more than a thousand, as is desired in current neuroscience research.

Owing to the requirement of keeping the amplifiers as close as possible to the probe, the amplifier chips can be directly soldered on the flex cable. However, this creates a problem because the probes themselves are disposable items and often fail, while the amplifiers are not. As a result, integrating expensive neural amplifiers by permanently soldering them to flex cables that are permanently attached to the probe is not practical.

The above two problems will be solved by a direct flex to flex cable connector with customizable and modular junctions that can be used to repeatedly detach and connect flex cables. The neural interface (typically consisting of 64 to 2048 individual gold electrodes on a silicon substrate) will have one or more flex cables directly soldered onto the probe body, and on the other end, one or several (1-32) 64 channel amplifier chips are directly soldered onto one or several flex cables. The exact design and fabrication method of the connector should be customized to the number of wires in the flex cables.

### SUMMARY OF THE INVENTION

Based on the background described above, there is a need for apparatus, systems and methods for a direct flex cable to flex cable connection. According to some embodiments, a press fit connection of two flex cables is provided in an approach that completes a secure electrical connection using hardware that is lightweight and low profile. Further, in some embodiments, the preceding is achieved with a mechanism that allows for the repeated connection and disconnection of the flex cables.

According to one aspect, a mechanism provides for direct flex cable to flex cable connection used in a high-density neural interface for invasive electrical recordings in the brains of animal models. According to some embodiments, the mechanism is employed in neural interfaces that require a connection of anywhere from hundreds to thousands of individual recording sites to one or multiple neural amplifiers.

The embodiments described herein disconnect the amplifier system from the probe by directly soldering both to separate flex cables, and by using a customizable flex cable-to-flex cable connector to easily connect and disconnect each from the other as needed.

According to another aspect, a direct flex cable-to-flex cable connector includes customizable and modular junctions that can be used to repeatedly detach and connect flex cables. The neural interface (typically consisting of 64 to 2048 individual gold electrodes on a silicon substrate) can have one or more flex cables directly soldered onto the probe body, and on the other end, one or several (1-32) 64 channel amplifier chips are directly soldered onto one or several flex cables. Depending on the embodiment, the exact design and fabrication method of the connector can be customized to the number of wires in the flex cables.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 illustrates a flex cable in accordance with one embodiment;

FIG. 2 illustrates a flex cable guide in accordance with a further embodiment;

FIG. 3 illustrates flex cable connector in accordance with still a further embodiment;

FIG. 4 illustrates flex cable alignment accordance with yet another embodiment; and

FIG. 5 illustrates a flex cable multi-connector in accordance with yet another embodiment.

### DETAILED DESCRIPTION OF THE DRAWINGS

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,”, “containing”, “involving”, and variations thereof herein, is meant to encompass the items listed thereafter and equivalents thereof as well as additional items.

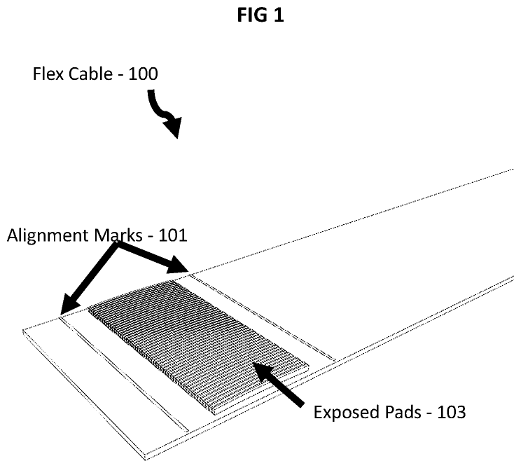

Referring to FIG. 1, a flex cable 100 is illustrated in accordance with one embodiment. According to this embodiment, the flex cable includes gold wires sandwiched between polyimide layers with exposed pad sections 103 employed to complete electrical connections. According to some embodiments, the flex cable is manufactured using nanofabrication methods in which polyimide is spun on a silicon substrate material, gold or aluminum is sputtered (hundreds of nm) on the surface of the substrate before being patterned by photolithography and liftoff. According to these embodiments, a top layer of polyimide is then spun over everything and etched in specific sections. The process exposes the wires where more gold or aluminum is sputtered forming contact pads. According to one embodiment, a 512-wire flex cable e.g. would have a total dimension of a few mm.

The small size and close spacing of the conductive contact pads requires a highly precise alignment of two flex cables to complete the electrical connections and prevent short circuits. In various embodiments, alignment guides and alignment markers 101 are included to precisely align corresponding pads on the flex cables to be connected during insertion into the connector. Depending on the embodiment, the alignment guides and markers can be made from plastic, metal or etched silicon manufactured to a precise minimum tolerance. The precision tolerance results in exposed pads on the respective cables that are precisely aligned relative to one another when the flex cables are pressed into engagement to complete the electrical connections. The precise minimum tolerances allow electrical connections to be completed by ensuring surface areas of exposed pads are properly aligned despite the micron tolerances required of the application. The embodiments described herein can include other features to assist with the preceding. In further embodiments, additional structures can be included in the contact pads to assist with the same, for example, a tongue and groove mechanism can be included in the exposed pads according to one embodiment.

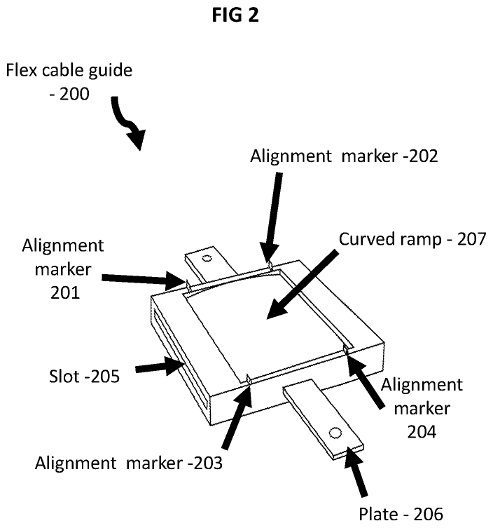

Referring to FIG. 2 a flex cable guide 200 is illustrated in accordance with one embodiment. According to this embodiment, the guide includes a slot 205 that has a curved ramp 207 that is open on one side and alignment markers 201-204. The curved ramp gently bends an inserted flex cable upwards, placing its exposed pads protruding slightly from the top profile of the guide at the open section when fully inserted. This protrusion from the curved slot ramps ensures that upon bringing two flex cable guides close together by use of the plate 206, complementary contact pads on the flex cables to be connected are brought into firm electrical contact without interference from the rest of the guide structure. In addition, the slots are designed with tight tolerances so as to perfectly laterally align complementary pads. In addition, according to this embodiment, the guide contains alignment markers 201-204 on the side that will be matched with complementary markers in the flex cable during insertion, for alignment along the insertion axis.

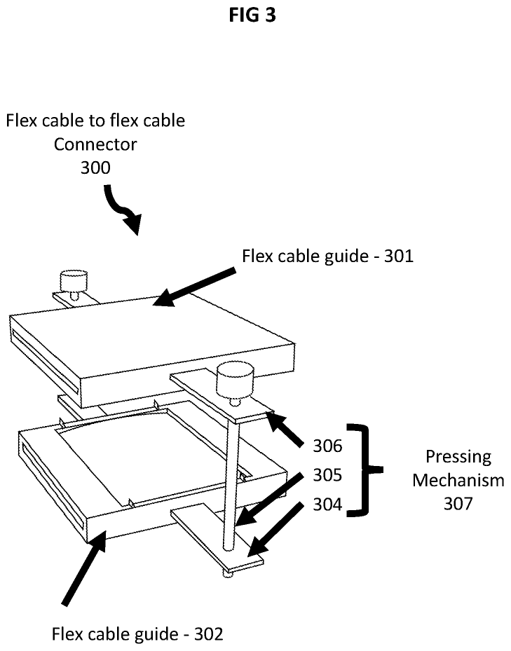

Referring to FIG. 3, flex cable to flex cable connector 300 is illustrated in accordance with one embodiment. According to this embodiment, the connector includes two complementary flex cable guides 301 and 302 respectively held together and perfectly aligned to each other by a pressing mechanism 307. Further according to this embodiment, the pressing mechanism 307 includes a first plate 306, a second plate 304 and a fastener 305. In this embodiment, the two plates 304, 306 are integrated into the flex cable guides 302 and 301 respectively. In operation, with the flex cable guides 301, 302 properly aligned, the fastener 305 is tightened to squeeze the plates 306, 304 together by pressing with the first plate 306 pressing on the underside of the first alignment guide 301 and the second plate 304 pressing on the top surface of the second alignment element 302. The contact pads of the respective flex cables when inserted into 301, 302 are aligned and pressed together to complete the desired electrical connection. The connection can easily be disconnected by loosening the fastener 305 and physically separating the two guides 301, 302 which separates their respective flex cables that would be inserted.

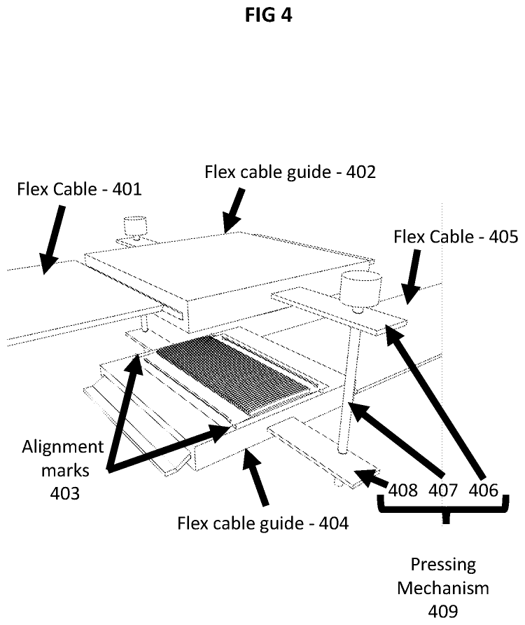

Referring to FIG. 4, an apparatus for flex cable alignment is illustrated in accordance with one embodiment. In the illustrated embodiment, a lower flex cable 405 is inserted into a lower flex cable guide 404 where the alignment marks on both the flex cable and flex cable guide are matched 403 for perfect alignment to each other. An upper flex cable 401 similarly inserted into a top flex cable guide 402 is perfectly aligned both laterally and horizontally to the lower flex cable by the pressing mechanism 307 which aligns the two flex cable guides containing inserted and aligned flex cables perfectly in position. As mentioned above, contact pressure can be applied to secure the connections between complementary flex cables.

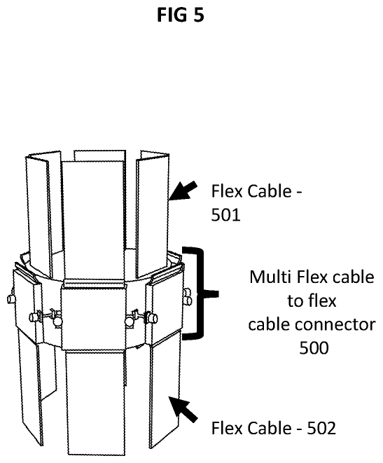

The approaches described herein can be scaled to provide configurations that facilitate a connection of thousands of conductors at micron-tolerances. For example, FIG. 5 illustrates a flex cable multi-connector 500 in accordance with yet another embodiment. According to this embodiment, multiple flex cable press connectors as illustrated in FIG. 4 are employed together in a single assembly to connect several pairs of flex cables, respectively.

Having thus described several aspects of at least one embodiment of this invention, it is to be appreciated various alterations, modifications, and improvements will readily occur to those skilled in the art. Such alterations, modifications, and improvements are intended to be part of this disclosure and are intended to be within the spirit and scope of the invention. Accordingly, the foregoing description and drawings are by way of example only.

1. An apparatus, system and method for a direct flex cable to flex cable electrical and physical connection, comprising of guides in which the flex cables with exposed conductor pads are aligned when inserted, and in which a pressing mechanism brings the guides into alignment with each other and upon latching brings corresponding exposed conductor pads on the flex cables into firm physical contact with sufficient force to ensure electrical connection.
connection system according to claim 1 whereby the guides have alignment marks on their external surface with which corresponding alignment marks on flex cables can be matched during insertion, aiding alignment.
connection system according to claims 1 and 2 whereby the pressing mechanism in its latched state perfectly aligns complementary contact pads in the flex cables to be connected and brings them into strong physical contact and ensures firm electrical contact.
